(19) United States
(12) Patent Application Publication
(10) Pub. No.: US 2001/0053700 A1
(43) Pub. Date: Dec. 20, 2001

(54) Communication system with secondary channel rebroadcasting within a local area network

(75) Inventor: Erin H. Sibley, Los Angeles, CA (US)

Correspondence Address: HUGHES ELECTRONICS CORPORATION, PATENT DOCKET ADMINISTRATION, BLDG 001 M/S A109, P O BOX 956, EL SEGUNDO, CA, 902450956

(73) Assignee: HUGHES ELECTRONICS CORPORATION

(21) Appl. No.: 09/844,919

(22) Filed: Apr. 26, 2001

Related U.S. Application Data
(63) Continuation-in-part of application No. 09/564,082, filed on May 3, 2000.
(60) Provisional application No. 60/249,153, filed on Nov. 16, 2000.
(60) Provisional application No. 60/262,811, filed on Jan. 19, 2001.
(60) Provisional application No. 60/268,482, filed on Feb. 12, 2001.
(60) Provisional application No. 60/271,578, filed on Feb. 22, 2001.
(60) Provisional application No. 60/272,741, filed on Mar. 1, 2001.

(51) Int. Cl. H04H 7/00

(52) U.S. Cl. 455/517; 455/466; 455/3.06

(57) ABSTRACT

A system of distributing electronic content includes a network operations center forming a composite broadcast signal having digital electronic content during a vertical blanking interval of a primary channel signal. A content delivery system receives the composite broadcast signal from the network operations center and broadcasts the composite broadcast signal. A base station receives the composite broadcast signal forms a wireless local area network. The base station rebroadcasts at least a portion of the composite signal as a rebroadcast signal using the wireless local network. A user appliance is positioned within the local area network and receives the rebroadcast signal.

### RELATED APPLICATIONS

The present application is a continuation-in-part of Ser. No. 09/564,082 (PD-200027) filed on May 3, 2000. The present application claims priority to provisional applications each of which are incorporated by reference herein as follows: Ser. Nos. 60/249,153 (PD-200352) filed on Nov. 16, 2000, entitled “Mobile Multimedia Subscription Programming Delivery System”; Ser. No. 60/262,811 (PD-201008) filed on Jan. 19, 2001, entitled “A New Method For Delivering In-Vehicle Entertainment Services”; Ser. No. 60/268,482 (PD-201027) filed on Feb. 12, 2001, entitled “Portable Handheld Devices To Receive Digital Over The Air Broadcasts”; Ser. No. 60/271,578 (PD-201029) filed on Feb. 22, 2001, entitled “A New Method And System For Delivering Mobile Direct To Home Entertainment Services” and Ser. No. 60/272,741 (PD-201030) filed on Mar. 1, 2001, entitled “A New Method And System For Delivering Entertainment To Portable Devices”. The present application is also related to U.S. patent applications as follows: entitled “Digital Over-The-Air Communication System For Use With Analog Terrestrial Broadcasting System” (Attorney Docket Number PD-200352A); “Digital Over-The-Air Communication System For Use With Digital Terrestrial Broadcasting System” (Attorney Docket Number PD-201008A); “Portable Device For Use With Digital Over-The-Air Communication System For Use With Terrestrial Broadcasting System” (Attorney Docket Number PD-201027A); “Communication System For Rebroadcasting Electronic Content Within A Local Area Network” (Attorney Docket Number PD-201030A) filed simultaneously herewith and incorporated by reference herein.

### TECHNICAL FIELD

The present invention relates generally to broadcasting digital information, and more specifically, to distributing electronic content using unused portions of over-the air broadcasting signals and rebroadcasting the electronic content within a local area network.

### BACKGROUND ART

Hughes Electronics Corporation provides digital direct broadcast systems such as DIRECTV® and DIRECPC™ that broadcast via satellite, television programs and information or computer applications, respectively. DIRECTV® broadcasts television programming in a similar fashion to that of terrestrial television. DIRECPC™ subscribers place requests that are queued up and broadcast, to the subscriber's computer. DIRECPC™ services on-demand requests. DIRECTV® and DIRECPC™ incorporate encryption in addressing for applications such as on-demand requests. These systems provide access control where users make selection decisions in advance of the content being broadcast.

The systems described above are all satellite-based systems. That is, each of the systems delivers content directly from a network operations center to a satellite that broadcasts the information to the users. Such systems, however, require the placement of a satellite dish on the building in which the service is used. The satellite dishes must be positioned in a location on the building so that they are positioned toward the geostationary satellite generating the broadcast signals. If the “view” to the satellite is blocked by trees or other buildings, the service cannot be used. Also, some consumers view the satellite dishes as not aesthetically pleasing.

Mobile devices such as cellular phones and personal digital assistants are increasing their presence in the marketplace. The functionality of such devices is increasing to such applications as the internet. However, such devices have heretofore been limited to internet applications.

Satellite connectivity to mobile devices has typically been expensive due to the size and complexity of antennas desired. Therefore, it was previously assumed that no economical method for delivering cable-like channels to mobile devices was practical.

It would therefore be desirable to provide cable-like TV channels to mobile devices in a reliable and cost effective manner.

### SUMMARY OF THE INVENTION

The present invention provides a system that combines satellite broadcasting with over-the-air broadcasting to bring service to both fixed and mobile users.

In one aspect of the invention, a system of distributing electronic content includes a network operations center forming a composite broadcast signal having digital electronic content during a vertical blanking interval of a primary channel signal. A content delivery system receives the composite broadcast signal from the network operations center and broadcasts the composite broadcast signal. A base station receives the composite broadcast signal forms a wireless local area network. The base station rebroadcasts at least a portion of the composite signal as a rebroadcast signal using the wireless local network. A user appliance is positioned within the local area network and receives the rebroadcast signal.

In a further aspect of the invention, a method for distributing electronic content comprises the steps of:

a network operations center forming a composite broadcast signal having digital electronic content during a vertical blanking interval of a primary channel signal;

a content delivery system receiving said composite broadcast signal from said network operations center and broadcasting said composite broadcast signal;

a base station receiving said composite broadcast signal and forming a wireless local area network, said base station rebroadcasting at least a portion of said composite signal as a rebroadcast signal using said wireless local network; and

a user appliance positioned with said local area network and receiving said rebroadcast signal.

One advantage of the invention is that the system may be used with fixed and mobile user devices. The user devices, because they receive over-the-air broadcasting, are lower cost than satellite-based devices. Satellite systems for mobile or portable uses are limited by the size of the antenna required to receive a direct signal.

Another advantage of the invention is that an on-demand type service may be offered in an over-the-air broadcast system. The broadcasting system may advantageously be formed from the current analog system or may be incorporated into the future digital broadcasting system.

Other features and advantages of the present invention will become apparent when viewed in light of the detailed description of the preferred embodiment when taken in conjunction with the attached drawings and appended claims.

BRIEF DESCRIPTION OF THE DRAWINGS

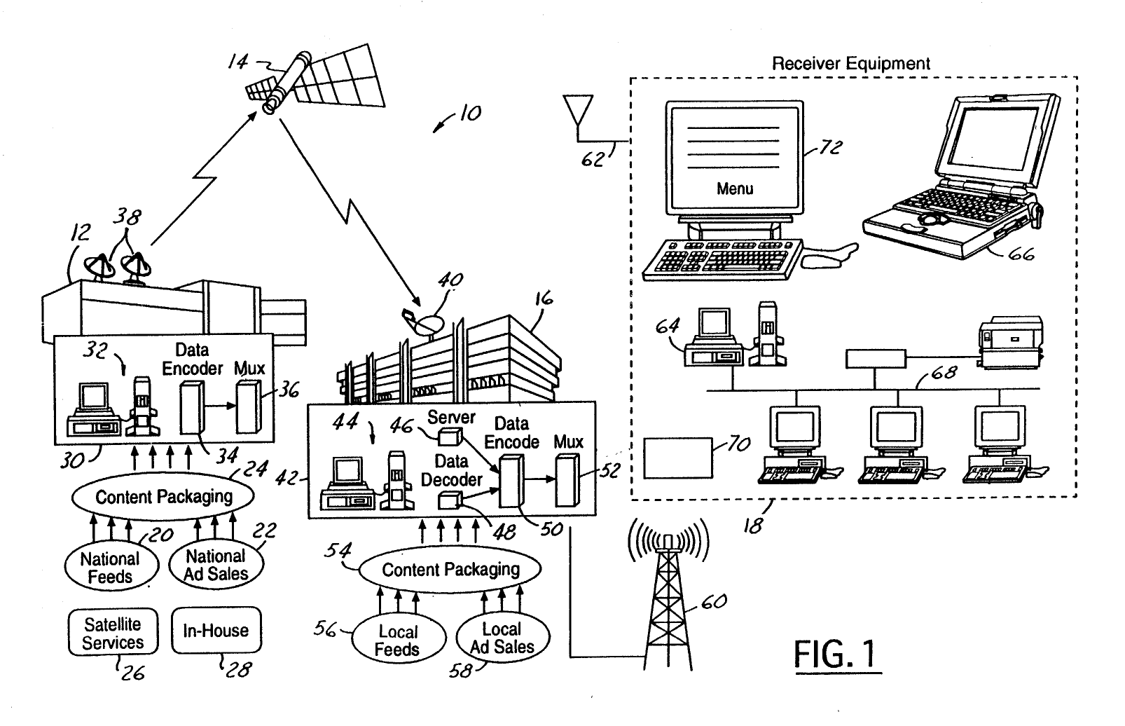

FIG. 1 is a diagrammatic view of the system architecture of a system according to the present invention.

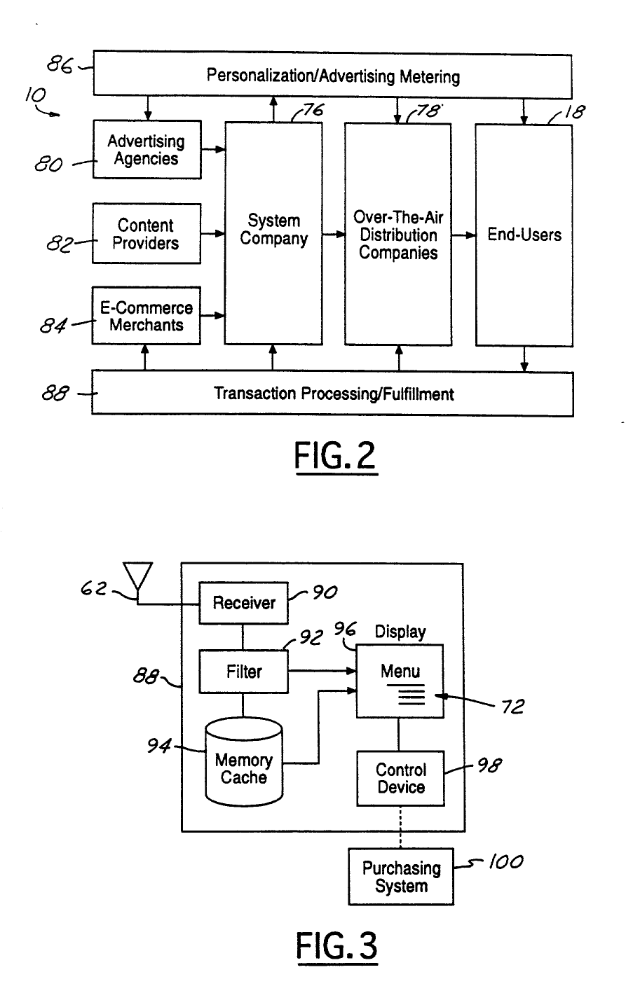

FIG. 2 is a block diagrammatic view of the business interactions of the present invention.

FIG. 3 is a block diagrammatic view of a user device for use in the present invention.

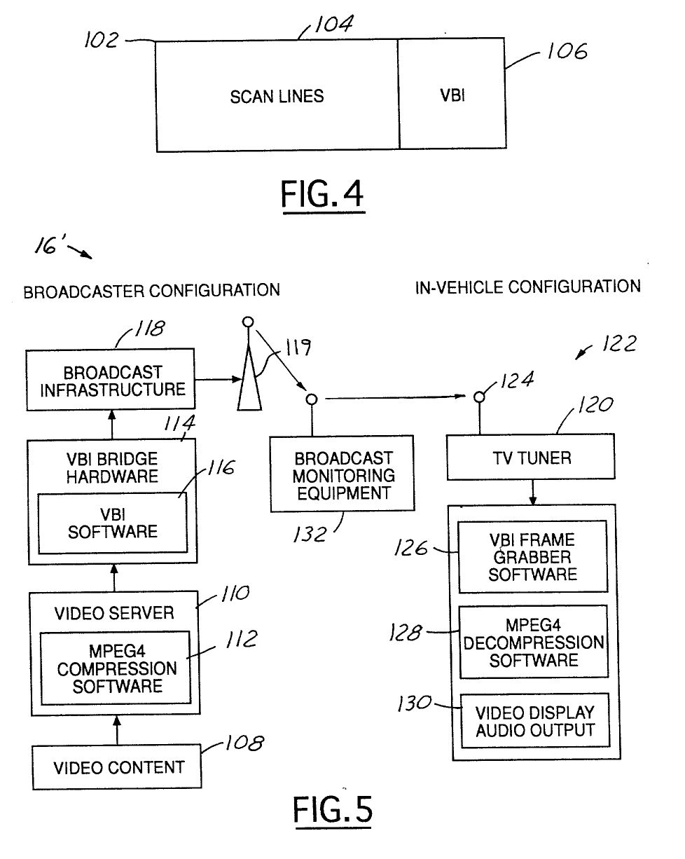

FIG. 4 is a representation of an analog signal having a vertical blanking interval.

FIG. 5 is a high level block diagrammatic view of a broadcast system for a vertical blanking interval according to the present invention.

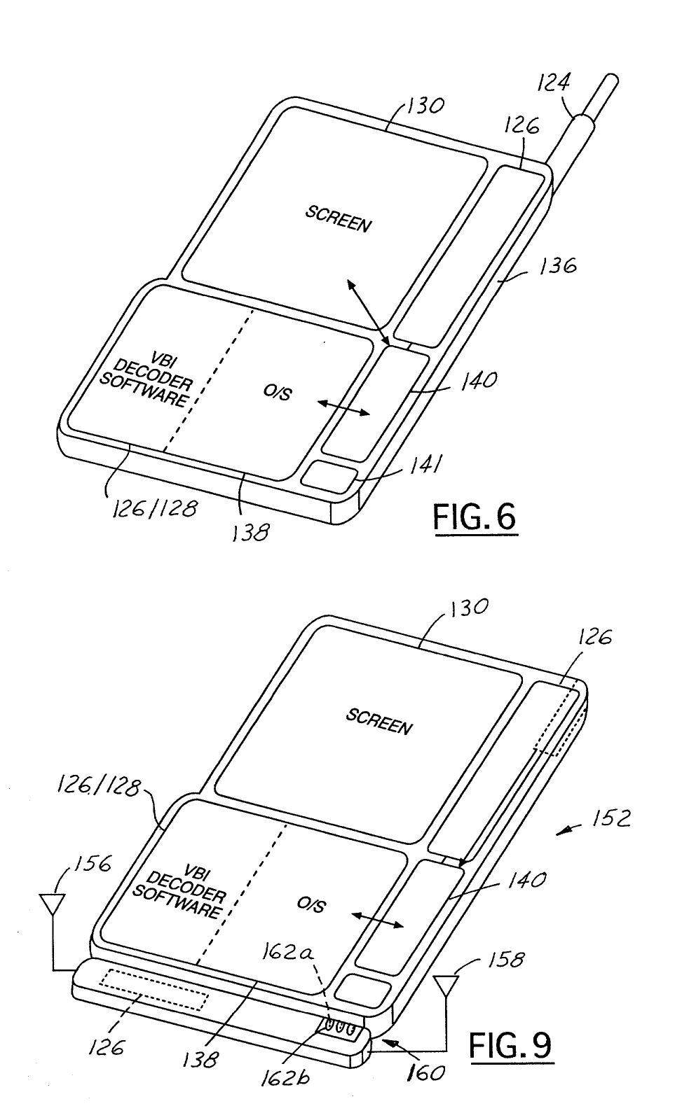

FIG. 6 is a block diagrammatic view of a personal digital assistant having vertical blanking interval reception according to the present invention.

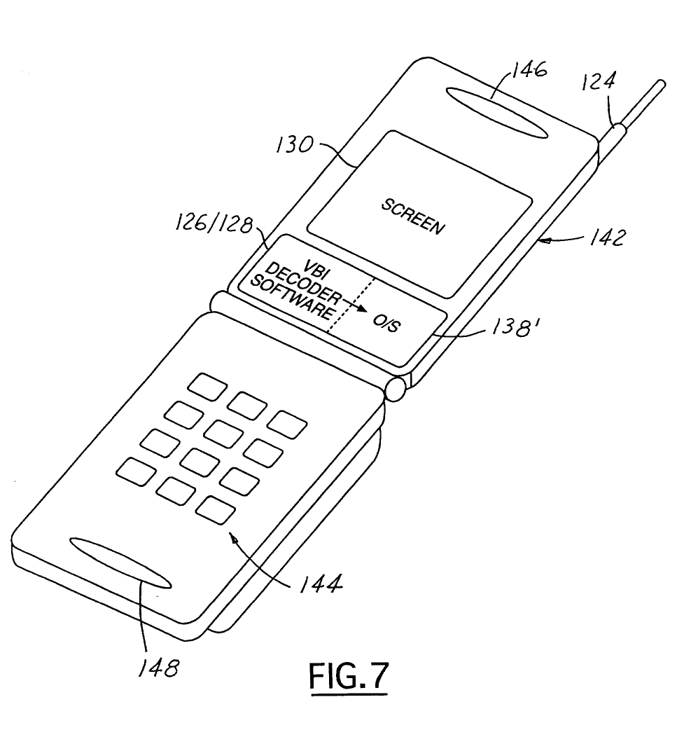

FIG. 7 is a block diagrammatic view of a cellular phone having a vertical blanking interval reception according to the present invention.

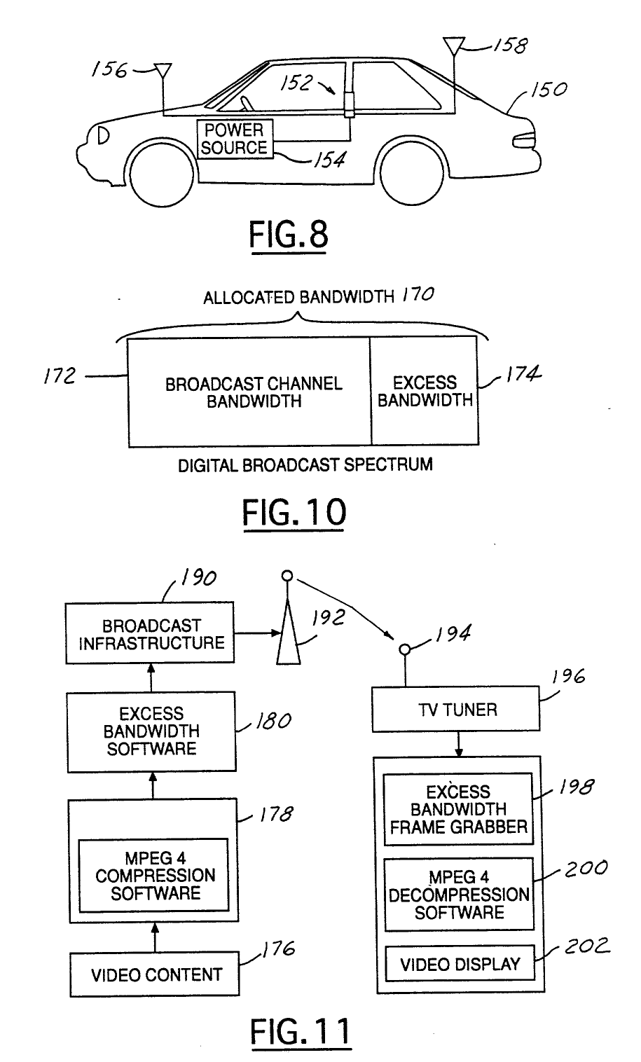

FIG. 8 is a block diagrammatic view of an automotive vehicle having a mobile device according to the present invention.

FIG. 9 is a more detailed block diagrammatic view of a mobile device according to FIG. 8.

FIG. 10 is a representation of an allocated bandwidth for high definition television.

FIG. 11 is a block diagrammatic view of a broadcast and reception system according to the present invention for use with a high definition television system.

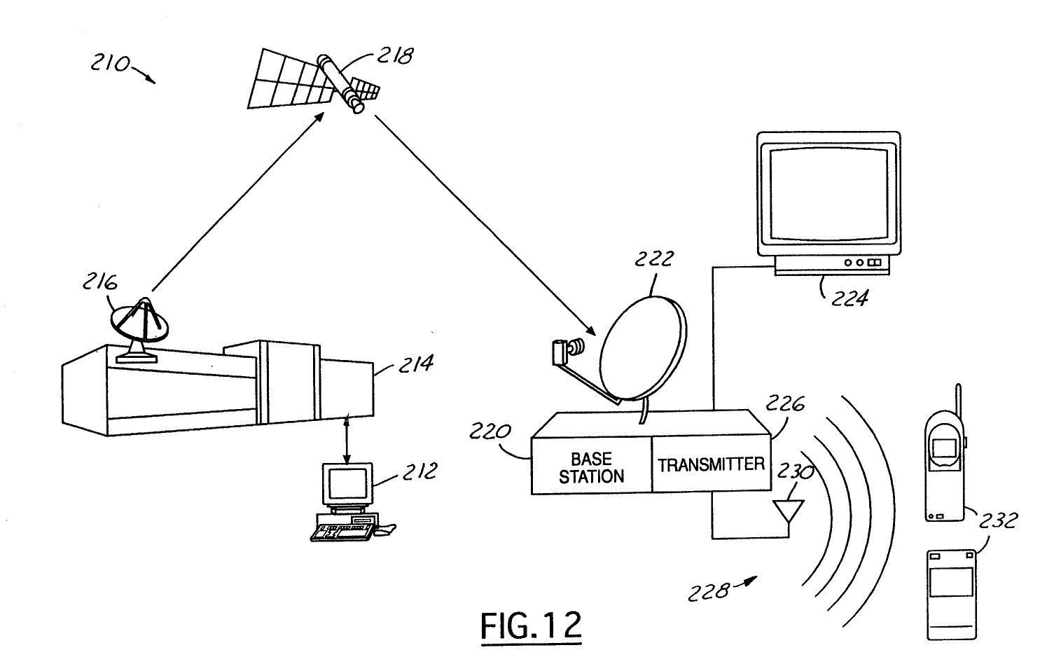

FIG. 12 is an alternative block diagrammatic view of a system according to the present invention.

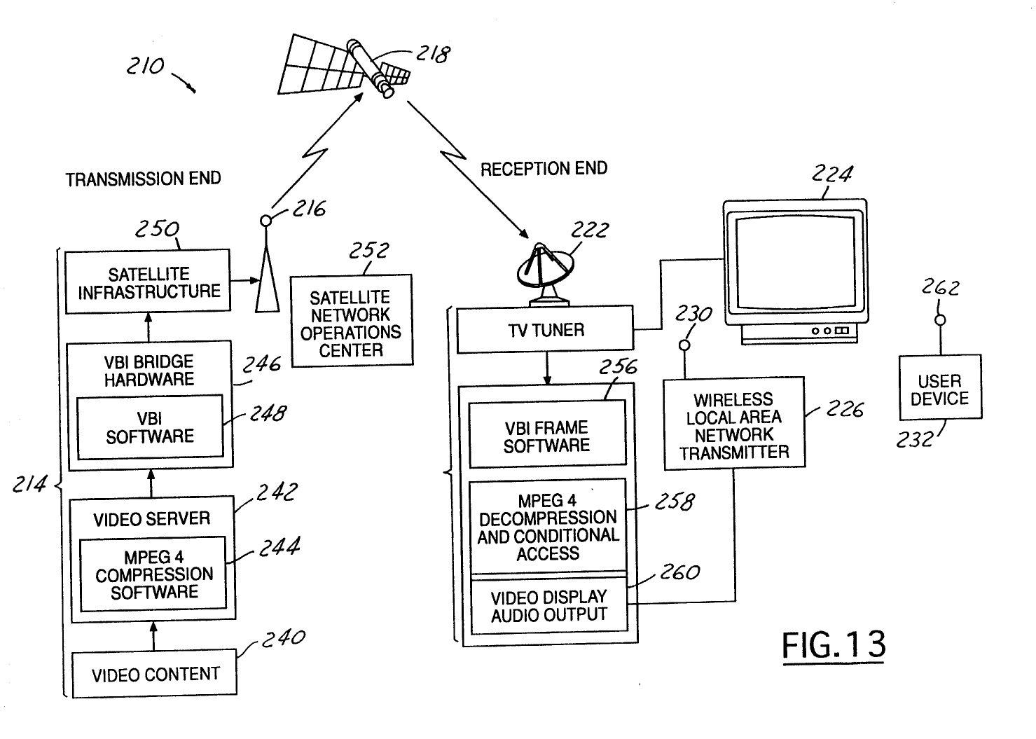

FIG. 13 is a more detailed block diagrammatic view of a system according to the present invention.

### BEST MODES FOR CARRYING OUT THE INVENTION

In the following figures the same reference numerals will be used to identify the same components in the various views.

As described in this application, “electronic content” is meant to encompass various types of digital information including the distribution of music, videos, movies, music videos, games, advertising and promotional materials associated with the content. “Electronic content” may also include cable-type television programming that includes wide variety of multi-channel content.

Referring now to FIG. 1, electronic content distribution system 10 is illustrated. Electronic distribution system 10 generally has a network operations center (NOC) 12, a satellite 14 in communication with NOC 12, an over-the-air broadcast center 16 that is coupled to users 18 over the air. The network operations center 12 is coupled to national feeds 20 and national ad sales 22 through content packaging 24. National feeds 20 may, for example, be national “cable” type services channels or satellite service such as DIRECPC™ or DIRECTV®. The national ad sales 22 may be derived in-house 28 or as will be further described below may be obtained from various promotional ad agencies. A content packaging block 24 is coupled to national feeds 20 and national ad sales 22. The content packaging 24 functions to couple national feeds 20 with national ad sales 22.

The network operations center 12 has a control system that includes various computers 32, a data encoder 34, and a multiplexer 36 that are coupled to antennas 38 that uplink electronic content to satellite 14. The control system 30 operates in a manner known to those skilled in the art.

Over-the-air broadcast center 16 has an antenna 40 that receives downlink signals from satellite 14. Over-the-air broadcast center 16 has a control system 42 that comprises a control computer 44, a server 46, a data decoder 48, a data encoder 50, and a multiplexer 52. Control system 42 is coupled to content packaging 54 which in turn is coupled to local feeds 56 and local ad sales 58. The over-the-air broadcast center receives downlink signals from satellite 14. Control system 42 may also receive local channel feeds through local feeds 56 and may also provide local advertising content through local ad sales 58. The local feeds 56, local ad sales 58, and downlink signals from satellite 14 are combined in control system 42. Some of the information from satellite 14 may also be stored in server 46 for on-demand broadcasting.

Control system 42 is coupled to a wireless transmitter 60 that broadcasts the wireless signals to users 18. Wireless transmitter 60 may comprise a cell tower such as that used in cellular phones, a TV tower that broadcasts digital signals or a stratospheric platform positioned above a predetermined metropolitan area for broadcasting over-the-air signals. If the wireless transmitter 60 comprises a TV tower, the channels broadcast may be excess channels or bandwidth for a metropolitan area allocated in HDTV format. As will be further described below, to allow quick deployment of a system an HDTV format may not be relied upon. That is, the digital over-the-air content may be incorporated into unused portions of an analog television broadcast, i.e., the vertical blanking interval.

Users 18 are coupled to an antenna 62 used for receiving over-the-air broadcast signals. Users 18 may comprise a variety of devices such as a personal computer 64, a laptop computer 66, a network 68 or a hand-held device 70. Each of the devices is preferably coupled to an antenna 62 for receiving over-the-air signals. Each device may have the antenna 62 coupled therein or may be connected to a separate antenna such as that of an automotive vehicle. Hand-held device 70 may comprise a variety of devices such as a digital media receiver, a personal digital assistant, or other type of hand-held device. Preferably, each device associated with user 18 has a menu 72 or other selection apparatus such as buttons or switches for selecting electronic content broadcast by over-the-air broadcast center 16. Menu 72 may provide information to the user as to the current electronic content being broadcast or may provide an interface to the electronic content stored within the user device.

In operation, the network operations center 12 provides a substantial amount of the content to be broadcast by the over-the-air broadcast center 16. In an actual implementation, very few network operations centers are required. Preferably, only one network operations center 12 is provided. A substantial amount of programming is uplinked to satellite 14. Satellite 14 downlinks various electronic content to over-the-air broadcast centers 16 throughout the country. The over-the-air broadcast center 16 may also combine local content and local ads through local feeds 56 and local ad sales 58. Users 18 may also be coupled to broadcast center 16. Thus, if on-demand service is desired, broadcast center 16 through telephone wires or through a wireless medium may be contacted so that the broadcast center 16 broadcasts the information through wireless transmitter 60. As will be further described below, broadcast center 16 may track data so that affinity information may be broadcast with the electronic content so that the users may filter the electronic content and store the electronic content on the user devices.

Referring now to FIG. 2, a business level view of a electronic content distribution system 10 is illustrated according to the present invention. The electronic content distribution system 10 is centered around a system company 76. The system company 76 is responsible for the initial broadcast and uplinking of the electronic content. The system company 76 interfaces with over-the-air distribution companies 78. The over-the-air distribution companies 78 may be cellular phone systems, television stations, or may be a company owned system. The over-the-air distribution companies are generally coupled to the end users 18 through the over-the-air broadcast.

System company 76 may also be coupled to various outside sources such as advertising agency 80, content providers 82, and e-commerce merchants 84. The personalization/advertising metering box 86 may represent various aspects of system company, over-the-air distribution and advertising agencies 80. Although illustrated separately, box 86 may be incorporated into these other functions. Personalization/advertising metering box 86 monitors the transactions by users 18 and helps to formulate an affinity model that is used to provide affinity information along with the electronic content to end users 18 so that material likely to be desirable to the particular end users 18 may be stored at the end users 18. The end users 18 are also coupled to transaction processing/fulfillment box 88. The transaction processing/fulfillment box 88 is shown coupled to system company 76, over-the-air distribution company 78, and e-commerce merchants 84. Although illustrated as a separate box, transaction processing/fulfillment box 88 may be incorporated into system company 76, over-the-air distribution company 78, and e-commerce merchants 84.

It is envisioned that end users 18 may subscribe to a predetermined service such as a television programming package as well as being able to request certain electronic content on demand. This may be done through the menu system as described above. Upon selecting a desired electronic content from the menu, the user device may be coupled to transaction processing/fulfillment box 88 wherein the on-demand service is paid for and wherein the over-the-air distribution system 78 broadcasts the information to the end user 18. The over-the-air distribution system may also be used to provide a decryption key to end users 18 for information stored on the user devices but is encrypted.

Advertising agencies 80 may provide targeted advertising that is coupled to various specific content of content providers 82 to particularly target a specific market.

Referring now to FIG. 3, one embodiment of a user device 88 is illustrated. Each user device 88 preferably is coupled to an antenna 62 as described above. Antenna 62 is coupled to a receiver 90 that receives the over-the-air signals and converts them into a useful format. Receiver 90 is coupled to a filter 92 that has affinity information of the user therein. Filter 92 is coupled to a memory cache 94. Memory cache 94 and filter 92 are coupled to a display 96 that is used to display menu 72. A control device 98 is coupled to display 96 to allow selections of various menu items from memory cache 94. Control 98 may also be used to select streaming content information being received at receiver 93 through filter 92. Control 98 may, for example, be a touch pad, keyboard, touch screen or other device. Control device 98 may also be coupled to the purchasing system 100 such as transaction processing/fulfillment box 88 of FIG. 2 above.

One advantage of the invention is that user device 88 may be mobile or fixed. That is, home users as well as mobile users such as those using hand-held devices or those with laptop computers may benefit from the system. In operation, the over-the-air broadcast center 16 broadcasts a variety of information simultaneously. Receiver 90 receives all the information and through the use of filter 92 decides whether or not to store the information in memory cache 94. The electronic content may be full rights to the electronic content, may be an encrypted from of the electronic content, or may be an indicator for menu 72 that will allow the user to make an on-demand request for the information. Filter 92 has affinity information associated therewith so that the electronic content received by receiver 90 may be screened.

In the simplest form, the broadcast content may be cable TV channels packaged as a service much like the service DirecTV® provides to households. In a another embodiment, the broadcast electronic content may contain affinity information so that the filter 92 may compare the broadcast affinity information with the affinity information within the filter and thereby store only the potentially desirable electronic content in memory cache 94. For each item stored in memory cache 94, a menu item is displayed on display 96 so that the user may select the electronic content when desired.

If full rights are not given in the electronic content, the control device 98 may select purchasing the device from purchasing system 100. Thus, the receiver 90 may receive the on-demand information and/or a decryption key. The user device through menu 72 and display 96 may be also used to select various over-the-air streaming information from over-the-air broadcast center 16.

After purchasing the electronic content, the information may be provided to advertisers and to the network operations center 12 so that affinity information may be associated with the broadcast information. Data mining techniques may be also used at the network operations center 12 so that various affinity models may be generated to target specific audiences and markets. This information will form an affinity preference model for developing affinity preference models for content downloads. These affinity models may be periodically updated and as well, the filter terms located at the user device may also be updated.

Referring now to FIG. 4, as mentioned above, over-the-air broadcast center 16 may be used for broadcasting the digital electronic content signals for use with an analog television signal 102. Such a system may be used for simply broadcasting cable-like television channels to portable devices or may include the other functions noted above. The analog television signal 102 is a conventional analog signal having a scan line portion or primary channel 104 corresponding to a number of scan lines. The scan lines correspond to the information used to form the image on the television screen. After the scan line portion 104, a vertical blanking interval 106 is commonly broadcast. The vertical blanking interval 106 is essentially a pause before the next television signal with another set of scan lines and vertical blanking interval 106 is broadcast. The vertical blanking interval used in current analog systems typically employ about 24 scan lines. As mentioned above, the television signal 102 is an analog signal. Although an over-the-air analog signal has been described, the present invention may also be used in the vertical blanking interval of a digital satellite broadcast signal which will be described further in FIG. 12.

The present embodiment seeks to include electronic content in digital format during the vertical blanking interval 106. The digital signal is therefore superimposed upon the analog television signal 102. The electronic content during this time may also be referred to as a secondary channel.

Referring now to FIG. 5, a second embodiment of an over-the-air broadcast center 16′ is illustrated. In this embodiment, video content, whether local or through a satellite such as the one illustrated in FIG. 1, is provided to over-the-air broadcast center 16′. Video content 108 is provided to a video server 110 that has video compression software 112 therein. A suitable video compression may, for example, use MPEG 4 compression software 112. Such software is known to those skilled in the art. The digital video content 108 is then compressed by software 112 and provided to vertical blanking interval bridge hardware 114. Vertical blanking interval bridge hardware 114 may include vertical blanking interval software 116 which is used to superimpose the compressed digital signal onto the vertical blanking interval of the broadcast television signal. The combined signal is coupled to broadcast infrastructure 118 where the combined signal is then transmitted over the air with a broadcast antenna 119. Broadcast infrastructure 118 and antenna 119 may have components of the type described above in FIG. 1.

A mobile device 122 capable of receiving the over-the-air broadcasts from broadcast antenna 119 is illustrated. Mobile device 122 may be one of the numerous devices described above in connection with FIG. 3. Exemplary devices include a personal digital assistant or a cellular phone. The present invention includes circuitry to receive the electronic content in addition to the functions of the device. For example, a personal digital assistant may still have calendaring and contact information as well as providing a display screen for displaying the received digital broadcast signal. A cellular phone, for example, may also include the capability of receiving telephone signals as well. To carry through with the vertical blanking interval electronic content broadcast by broadcast infrastructure 118, an antenna 124 is used to receive the entire broadcast television signal from antenna 119. This entire television signal includes both the regular broadcast channel as well as the digital electronic content embedded within the vertical blanking interval. A TV tuner 120 is incorporated into the mobile device 122 so that selections of different programming may be accomplished. Vertical blanking interval frame grabbing software 126 is used to receive a compressed digital video signal transmitted within the vertical blanking interval of the broadcast signal. The frame grabbing software 126 is coupled to decompression software 128 to decompress the compressed video signal. The decompressed video signal from decompression software 128 is displayed on an output device 130. Decompression software 128 may also include conditional access software. Conditional access software allows for only authorized viewing of the digital content on a memory. Such conditional access may be software coded into the device or provided on a separate card in a manner similar to that of the DIRECTV® system. Speakers may also be incorporated into output device 130 to provide audio simultaneously with the video.

Advantageously, the present invention allows over-the-air broadcast signals to act as a carrier for the digital electronic content desired to be provided to mobile users. While the emphasis is on mobile users, stationary users may also be serviced by such a system.

Monitoring equipment 132 may also be incorporated into the system. The monitoring equipment 132 provides feedback to the broadcast center corresponding to the quality of the signals so that adjustments may be made.

Referring now to FIG. 6, a personal digital assistant 136 having the features according to the present invention are illustrated in a block diagrammatic form. The same reference numerals are used to illustrate the same components from FIG. 5. Personal digital assistant 136 has an operating system 138 which may be separate from the present invention. However, those skilled in the art will recognize that operating system 138 may include vertical blanking interval frame grabber software 126 and decompression and conditional access software 128 as a part thereof, as illustrated. Operating system 138 is coupled to various architectural elements 140 depending on the type of system. Architecture elements 140 are coupled to antenna 124 and to TV tuner 126. TV tuner 126, as above, allows the user to select the desired electronic content to be viewed on display 130. TV tuner 126 is thus coupled between architecture elements 140 and display 130. Architecture elements 140 may, for example, include an input device such as knobs, buttons, or switches for allowing the selection of various electronic content.

A power source 141 may also be included on the device. Power source 141 may be a battery or a rechargeable battery. This allows personal digital assistant 136 to be mobile. In addition to batteries, personal digital assistant 136 may also be powered with an AC adapter.

Referring now to FIG. 7, a cellular phone 142 is illustrated having the broadcast reception capability described above. In this embodiment, cellular phone 142 has an operating system 138′ that supports the traditional cellular phone elements as well as those described above with respect to FIG. 6. Cellular phone 142 may also include a touch pad 144, an ear speaker 146, and a microphone 148 to support the cellular phone application.

Referring now to FIG. 8, the present invention is particularly suited for mobile use such as in an automotive vehicle 150. Automotive vehicle 150 may incorporate a mobile device 152 therein. Mobile device 152 may be coupled to a vehicle power source 154 such as the vehicle battery. Also, mobile device 152 is preferably coupled to a first vehicle antenna 56 and preferably to a second vehicle antenna 158.

Referring now also to FIG. 9, the same reference numerals are used to identify the same components from that of FIG. 6. Mobile device 152 may be coupled in a cradle 160. Cradle 160 may be coupled to vehicle power source 154 and to antennas 156 and 158. A connector 162 having a male portion 162A and a female portion 162B may be respectively coupled on mobile device 152 and connector 162. As illustrated, mobile device 152 is removable from cradle 160. However, in some automotive applications, mobile device 152 may be coupled fixedly to cradle 160. Cradle 160 may also have other electrical circuitry therein used for operating mobile device 152. As illustrated in dashed lines, TV tuner 126 may also be incorporated into cradle 160. Such a device would be suitable for a removable portable digital assistant wherein only the television tuner aspects are desired when mounted within cradle 160.

Referring now to FIG. 10, the present invention may also be suitable for use in an HDTV broadcasting environment. Governmental bodies have regulated the HDTV environment by providing an allocated bandwidth 170. The allocated bandwidth for a channel in the United States is 6 MHz. The allocated bandwidth 170 is less than the broadcast channel bandwidth 172 over which the television stations will broadcast the television signal. Thus, excess bandwidth 174 remains.

Referring now also to FIG. 11, a similar figure to that of FIG. 5 except rather than broadcasting over the vertical blanking interval, the excess bandwidth of the allocated bandwidth for a digital television signal is utilized to broadcast the digital signal. In this embodiment, video content 176 is provided to MPEG 4 compression 178. Excess bandwidth software is used to couple the regularly broadcast signal with the electronic content. Both signals are broadcast through broadcast infrastructure 190 through antenna 192. A receiving antenna 194 coupled to TV tuner 196 is used to receive the electronic content signal. An excess bandwidth frame grabber 198 grabs the electronic content from the excess bandwidth and provides it to decompressor 200. The decompressed video content is displayed on display 202 in a similar manner to that described above. Decompressor 200 may also include conditional access software as described above.

In operation, the system operator uplinks a plurality of electronic content packages to a satellite. These electronic content packages are preferably a subscriber type package such as that provided by DIRECTV® service. Preferably, at least a portion of the electronic content packages is common throughout the region or country. The electronic content packages are received from the satellite by the various over-the-air broadcasters. The over-the-air broadcasting broadcasts their regular signals and in addition, the digital electronic content. In the case of an analog television channel, the digital signal is superimposed over the vertical blanking interval of the signal. In the case of an HDTV signal, the digital content is provided in the excess bandwidth. The electronic content packages are received in a user appliance or device where either the analog signal or the HDTV signal are preferably disregarded except for the electronic content packages. Purchasers of the service are granted access by purchasing the conditional access software either directly (e.g. in a format card) or indirectly (e.g. purchasing an enabled device). Thus, the electronic content packages are granted access to, decompressed and displayed on the display device and any audio signals are heard through any speaker device incorporated within the user device.

Referring now to FIG. 12, another embodiment of the present invention is illustrated. The present invention may also be embodied in various types of content delivery systems such as a direct broadcast satellite system 210. In addition, a cable network or fiber optic network may also be used. The following description is directed to a direct broadcast satellite content delivery system. That is, a satellite 218 may be used to broadcast both a primary channel and a secondary channel during the vertical blanking interval of the primary channel as mentioned above. System 210 has feeds 212 which are a simplified version of those shown above in FIG. 1. Feeds 212 are meant to be inclusive of various types of feeds including local feeds and cable-type broadcast feeds. The feeds 212 are coupled together at broadcast center 214. The broadcast center 214 organizes the signal and directs the television signals through an antenna 216 to a satellite 218. The broadcast center thus organizes the signals into primary channels which contain a substantially greater amount of digital information than the secondary or vertical blanking interval channel broadcast during the vertical blanking interval of the primary channel.

Satellite 218 broadcasts the primary channel and the vertical blanking interval secondary channel to a particular service area. In a cable or fiber optic system the primary and secondary channels are delivered via a cable or fiber optic cable rather than satellite 218.

A base station 220 having a receiving antenna 222 is illustrated receiving both the primary channel and the secondary vertical broadcast interval channel. Base station 220 represents a variety of potential types of base stations. Base station 220 may, for example, be similar to that of a set top box for the DIRECTV® ( systems manufactured by the assignee of the present invention. Base station 220 is coupled to a television 224 in a conventional manner. Preferably, television 224 receives the primary channel from base station 220. In a cable or fiber optic system, base station 220 may be connected to the cable or fiber optic cable directly.

Base station 220 may also include a transmitter 226 which is used to form a local area wireless network 228 between a transmitting antenna 230 and user devices 232. Preferably, the secondary or vertical blanking interval channel is transmitted to the user devices 232 in a wireless manner. Transmission may take place using standard formats such as the Bluetooth format for wireless devices. The user devices 232 includes similar types of devices illustrated in FIGS. 6 and 7 such as cellular phones and personal digital assistants. Of course, those skilled in the art will recognize that various types of wireless devices configured to receive the frequencies broadcast by transmitter 226 may be employed.

Various uses for such a system will be evident to those skilled in the art. One use envisioned for such a device is for residential use so that both the primary channel may be enjoyed by watching television 224 while users throughout the house and nearby surroundings may enjoy the secondary channel broadcast during the vertical blanking interval of the primary channel. Other uses include public buildings and public transportation. A base station may be employed on the building or public transportation to receive at minimum the secondary channel within the vertical blanking interval and rebroadcast the secondary channel to the mobile wireless devices. Examples of suitable public places include airports, shopping malls, arenas, subways, trains, buses and the like.

Referring now to FIG. 13, a more detailed block diagram of a broadcast system 210 is illustrated. FIG. 13 uses the same reference numerals for the same components as FIG. 12. Broadcast center 214 has similar content to FIG. 5. That is, video content 240 is provided to a video server 242 that has video compression software 244 therein. Similar video compression may be used as mentioned above with respect to software 112. The digital video content to be placed within the vertical blanking interval of the satellite broadcast signal is provided to vertical blanking interval bridge hardware 246 having vertical blanking interval software 248 therein. Vertical blanking interval software 248 is used to superimpose the compressed digital electronic content signal into the vertical blanking interval of the digital broadcast television signal. Vertical blanking interval bridge hardware 246 is coupled to satellite infrastructure 250 rather than broadcast infrastructure 118 as illustrated in FIG. 5. Thus, the vertical blanking interval of the digital broadcast satellite signal is transmitted from satellite infrastructure 250 through antenna 216 to digital broadcast satellite 218.

A satellite network operation center 252 may be employed to control the movement and quality of the signals broadcast from the satellite 218. Broadcast center 214 in addition to the structure illustrated in FIG. 13 broadcasts the digital broadcast signal in a conventional manner with the addition of the secondary or vertical broadcast interval channel therein.

Base station 220 includes antenna 222 for receiving the digital satellite broadcast signals described above. A tuner 254 may also be included therein for tuning various channels received through the digital broadcast signal. TV tuner 254 may include various numbers of individual tuners for the use of multiple users. The multiple users may include directly connected users such as a television 224 or mobile user devices 232. TV tuner 254 may also be configured to receive both primary and secondary broadcast channels. At minimum, TV tuner 254 is configured to receive secondary digital broadcast signals.

TV tuner 254 is coupled to vertical blanking interval frame software 256 which is used to receive the compressed digital video signal transmitted within the vertical blanking interval of the digital broadcast signal. Vertical blanking interval frame software 256 is coupled to decompression and conditional access software 258. As mentioned above, the present system is preferably a subscription type service which will be restricted through conditional access as described above. The electronic content forming the secondary channel is thus decompressed and allowed access to through decompression and conditional access software 258.

Video display and audio output 260 thus receives the electronic content forming the secondary channel which is then coupled to a wireless local area network transmitter 226. Wireless local area network transmitter 226 uses an antenna 230 to locally distribute the video display and audio output 260 to the user devices 232 using antenna 230 on the wireless local area network transmitter 226 and antenna 262 on user device 232. As mentioned above, wireless local area network preferably transmits the secondary channel using standard wireless technology such as Bluetooth or the 802.11 type interface. Preferably, the secondary channel has less digital video content that is suitable for retransmission to mobile devices. Typically, mobile devices do not include the processing power of high level devices such as set top boxes. Because mobile devices are smaller, the amount of content and thus the corresponding digital bits can be a lot smaller without losing the effect. This embodiment may also include another type of a high altitude communication device such as a stratospheric platform rather than a satellite. However, it is envisioned that a satellite will be more useful and reach more users than a stratospheric platform.

In operation, a primary channel having digital electronic content such as a secondary channel during a vertical blanking interval of the primary channel is uplinked to the high altitude communication device such as a satellite. The primary channel having the digital electronic content is received and over-the-air broadcast to the user devices where it is received, displayed, or heard. Preferably, a base station such as a set top box for the DIRECTV® system is modified to include the wireless local area network system described above. Such a system will provide an additional service for DIRECTV® users who require mobility.

The present invention advantageously uses the previously unused digitally vertical blanking interval of the digital satellite broadcast signal.

While particular embodiments of the invention have been shown and described, numerous variations alternate embodiments will occur to those skilled in the art. Accordingly, it is intended that the invention be limited only in terms of the appended claims.

What is claimed is:

1. A system of distributing electronic content comprising:
a network operations center forming a composite broadcast signal having digital electronic content during a vertical blanking interval of a primary channel signal;
a content delivery system receiving said composite broadcast signal from said network operations center and broadcasting said composite broadcast signal;
a base station receiving said composite broadcast signal and forming a wireless local area network, said base station rebroadcasting at least a portion of said composite signal as a rebroadcast signal using said wireless local network; and
a user appliance positioned with said local area network and receiving said rebroadcast signal.

2. A system as recited in claim 1 further comprising a television coupled to said base station, said television receiving at least a portion of said composite broadcast signal.

3. A system as recited in claim 2 wherein said base station couples said primary channel to said television.

4. A system as recited in claim 1 wherein said base station forms said rebroadcast signal from said digital electronic content.

5. A system as recited in claim 1 wherein said electronic content comprises digital audio signals.

6. A system as recited in claim 1 wherein said electronic content comprises video.

7. A system as recited in claim 1 wherein said content delivery system comprises high altitude device.

8. A system as recited in claim 1 wherein said high altitude device comprises a satellite.

9. A system as recited in claim 1 wherein said high altitude device comprises a stratospheric platform.

10. A system as recited in claim 1 wherein said base station comprises an integrated receiver decoder.

11. A system as recited in claim 1 wherein said digital electronic content is compressed.

12. A system as recited in claim 1 wherein said content delivery system comprises a cable network.

13. A system as recited in claim 1 wherein said content delivery system comprises a fiber optic network.

14. A method of distributing electronic content comprising the steps of:
uplinking a primary channel signal having a digital electronic content during a vertical blanking interval of the primary channel signal to a high altitude device;
receiving the primary channel signal having a digital electronic content during a vertical blanking interval from the high altitude device;
over-the-air broadcasting the digital electronic content; and
receiving the electronic content packages through a user appliance.

15. A method as recited in claim 14 wherein the step of receiving over-the-air broadcasting comprises over-the-air broadcasting from a base station.

16. A method as recited in claim 14 wherein the step of receiving over-the-air broadcasting comprises over-the-air broadcasting from a base station within a building.

17. A method as recited in claim 14 further comprising the step of coupling the primary channel to a television.

18. A method of distributing electronic content comprising the steps of:
digitally compressing the electronic content into a digital video stream;
broadcasting a television signal having a vertical blanking interval;
broadcasting the digital video stream within the vertical blanking interval;
receiving the digital video stream;
rebroadcasting the digital video stream using a wireless local area network.

19. A method as recited in claim 18 further comprising the steps of coupling the television signal to a television.

20. A method as recited in claim 18 further comprising the steps of receiving the electronic content in user appliance.

21. A method as recited in claim 20 wherein the step of receiving comprises the steps of digitally decompressing the digital video stream, and displaying the video stream.

22. A method as recited in claim 20 wherein the step of receiving comprises grabbing a vertical blanking interval frame.
